(19) United States
(12) Patent Application Publication
(10) Pub. No.: US 2009/0302077 A1
(43) Pub. Date: Dec. 10, 2009

(54) Bicycle Rack for Pick-up Trucks

(76) Inventors: Lyle Yee, Petaluma, CA (US); Brian Yee, San Francesco, CA (US)

Correspondence Address: BELL & ASSOCIATES, 58 West Portal Avenue No. 121, SAN FRANCISCO, CA, 94127, US

(21) Appl. No.: 12/479,983

(22) Filed: Jun. 8, 2009

Related U.S. Application Data
(60) Provisional application No. 61/131,309, filed on Jun. 6, 2008.

(51) Int. Cl. B60R 9/10

(52) U.S. Cl. 224/405; 224/539

(57) ABSTRACT

A bicycle rack made from tubular components that can be secured in the cargo bed of a pick-up truck without the use of any tools and wherein, in use, at least four bicycles, with both front and back wheels attached, are held in an upright position with both wheels down upon the truck bed.

### CROSS-REFERENCE TO RELATED APPLICATIONS

This application claims the benefit of and priority to provisional patent application Ser. No. 61/131,309 filed 6 Jun. 2008 titled “Bicycle Rack for Pick-up Trucks” by the inventors Lyle Yee and Brian Yee. This application is incorporated herein by reference for all purposes.

### FIELD OF THE INVENTION

This application relates generally to bicycle transport racks, particularly racks positionable within a bed of a pick-up truck for supporting a plurality of bicycles in a parallel, spaced relationship without damaging the bed of the pickup truck or the bicycles.

### BACKGROUND

The use of bicycle racks devised and utilized for transporting a single or plurality of bicycles in or on a vehicle is well known in prior art. A myriad of designs and structural configurations have been developed to fulfil their respective objectives, each with their disadvantages. The increased use of bicycles as recreational vehicles, particularly by those living in urban areas, has created a need for the development of bicycle transport systems. Coupled with the increased popularity of pick-up trucks and the desire to transport multiple bicycles simultaneously, this need for development is especially acute in bicycle racks designed specifically for pick-up trucks. Simply placing bicycles into the truck bed for transport allows the bicycles to come in contact with each other and other items stored in the truck bed while loading, in transit, and unloading, resulting in damage to the bicycles.

Some known bicycle racks for pick-up trucks attach the bicycles to the exterior of the truck. For example, U.S. Pat. No. 5,476,202 to Mehls (1999) attaches to the receiver hitch of the truck and U.S. Pat. No. 4,709,840 (1987) to Allen attaches to the tailgate of the truck. However, positioning a bicycle at the rear exterior of the truck bed exposes it to damage in rear-end collisions, restricts access to the tailgate, and may preclude use of the receiver hitch to tow. Another, U.S. Pat. No. 5,303,858 to Price (1994), includes a carrier mounted on the exterior sides of the truck bed. This positioning exposes the bicycle to serious damage in the event of a side collision and causes the handlebar and the pedals of the bicycle to protrude further out than a standard rearview mirror, increasing the risk of a collision.

Most known bicycle racks used inside the truck bed have very limited hauling capacity and/or require the user to either remove a wheel from the transported bicycle and/or to attach the rack to the truck bed in some kind of semi-permanent, often damaging, fashion. For example, U.S. Pat. No. 5,037,019 to Sokn (1991), U.S. Pat. No. 4,934,572 to Bowman and Northey (1990), and U.S. Pat. No. 5,699,945 to Micklish (1997) include a bracket which clamps onto the front or a side rail of the truck bed and attaches to the front fork of the bicycle. However,

the bracket can only accommodate a single bicycle in addition to required removal of the front wheel of the bicycle. The restrictive hauling capacity of these devices requires the user to purchase and install multiple devices if they wish to transport more than one bicycle, costing the user additional time, energy, and expense. Another example, U.S. Pat. No. 5,092,504 to Hannes and Cowles (1992), includes an extendible longitudinal bar on mounting brackets and allows transport of multiple bicycles, but still requires the user to remove the front wheel of the bicycles in order to attach the front fork of the bicycle to the bar. Removal of the front wheel requires the user of the device to expend additional time and energy physically removing the wheel and requires the user to find alternate safe storage means for the separated wheel.

Other known art require disfigurement of the truck itself in order to mount the rack, such as U.S. Pat. No. 6,834,786 to Hansen (2004) and U.S. Pat. No. 5,836,490 to Price (2002) which include an elongated longitudinal beam that connects to the sides of the truck bed by screws and requires holes to be drilled into the truck bed. In addition to permanently altering the truck bed, racks of this nature require tools, additional time, and effort to install and remove.

In addition to the disadvantages described, the bicycle racks mentioned above can not be easily or inexpensively made by the user. They require tools, relatively expensive materials, and experience in arts such as welding.

In summary, all bicycles racks made for use with a truck bed heretofore known suffer from one or more of the following disadvantages: bicycle positioning that makes the bicycle susceptible to damage in a collision or increase the likelihood of a collision, restricted access to the tailgate, restricted access to the receiver hitch, extremely limited hauling capacity, required removal of the front bicycle wheel, permanent disfigurement of the truck bed, and difficult assembly, installation, or removal.

### SUMMARY OF THE INVENTION

In one embodiment the invention comprises a bicycle rack sized and adapted for use with a truck having a truck bed with substantially parallel side walls, and at least one bicycle having a frame and a wheel mounted on the rear or front bicycle fork of said frame, said bicycle rack including at least two outer vertical bars and a plurality of inner vertical bars arranged in generally parallel relation to each other by at least one horizontal support adapted to extend longitudinally between side walls of said truck bed. At least one end of said inner vertical bars is attached to the horizontal support(s), creating generally rectangular slots to receive said bicycle wheel. Said horizontal support(s) are attached to said outer vertical bars, which are positioned against side walls of said truck bed, preventing the bicycle rack from moving longitudinally. At minimum, the bottom ends of the outer vertical bars are orthogonally attached to support members adapted to extend from the rear wheel well of the truck bed to the tailgate of the truck, preventing bicycle rack from moving laterally.

The invention may be summarized as a rack positionable within a bed of a pick-up truck for supporting a plurality of bicycles in a parallel, spaced relationship without damaging the bed of the pickup truck or the bicycles. One embodiment of the rack comprises two side frames (26) and a central frame (36). Said side frames (26) include a plurality of latitudinal support members (18) and a plurality of outer vertical bars (16). One pair of parallel latitudinal support members (18) is positioned against the right side of the truck bed between the right rear wheel well and the right side of the tailgate and another pair of said parallel latitudinal support members (18) is positioned against the left side of the truck bed between the left rear wheel and the left side of the tailgate. The right support members (18) are connected by orthogonal outer vertical bars (16) which attach to each end of the right support members (18) by ‘L’ connectors (22) and the left support members are connected by orthogonal outer vertical bars (16) which attach to each end of the left support members (10) by ‘L’ connectors (22), forming generally rectangular side frames (26). Said latitudinal support members (18) are positioned at parallel opposing sides of the truck bed are connected by a pair of longitudinal horizontal supports (12, 14) less the width of the truck bed. Because of said longitudinal horizontal supports (12, 14), no additional mounting means are needed to preclude longitudinal movement of the rack within the truck bed. Because of said support members (18), no additional mounting means are needed to preclude latitudinal movement of the rack within the truck bed. Said longitudinal horizontal supports (12, 14) are connected to latitudinal support members (18) by ‘T’ connectors (20). Central frame 36 comprises said horizontal supports (12, 14) and a plurality of inner vertical bars (24). Said longitudinal horizontal supports (12, 14) are made up of a plurality of alternating ‘T’ connectors (28, 32) and short horizontal supports (30, 34). Each upper ‘T’ connector (28) of the longitudinal upper horizontal support (12) connects to their parallel counterpart lower ‘T’ connector (32) on the longitudinal lower horizontal support (14) by orthogonally positioned inner vertical bars (24) forming a plurality of parallel support beams to place bicycle wheels in between.

The invention can be summarized alternately as: 1. The bicycle rack as shown and described herein and in the figures. 2. A bicycle rack made from a plurality of tubular plastic members which in use is adapted for stable positioning within the bed of a pick-up truck, that may be positioned without the use of any fastening hardware that clamps onto, or into, or glues to, or penetrates any part of the truck or the truck bed or bed liner, that does not require permanent or semi-permanent fixture of the rack to any part of the truck or the truck bed or bed liner, wherein installation and removal into the truck bed requires no tools such as wrenches or screwdrivers or Allan keys, wherein between 1 and 6 bicycles may be carried safely in an upright position. 3. A bicycle rack comprising three elements attachable and detachable to one another. (1) A main frame comprising a plurality or parallel struts positioned together in the same plane (the first plane), each strut having a first end and a second end, the struts secured between two joists positioned at the ends of the struts, the joists being perpendicular to the struts, and within the same first plane as the struts; (2) at either end of the main frame, two side frames each one comprising a polygonal frame the sides of which are all in the same second plane, wherein each side frame is attachable to joists of the main frame, the side frame, when in use, being positioned in a second plane that is orthogonal to first plane of the main frame, wherein the joists are longer than the struts. 4. The bicycle rack of claim 3 wherein the joists are longer than any one of the sides of the polygonal frame. 5. The bicycle rack of claim 3 wherein the polygonal frame has four sides. 6. The bicycle rack of claim 3 wherein the polygonal frame has three sides.

### FIGURES

These and other aspects of the invention will be better understood by reference to the following description of the invention in conjunction with the drawings, in which:

FIG. 1 is a perspective view of a rack made in accordance with the principles of one embodiment.

FIG. 2 is a top perspective view of the rack made in accordance with the principles of the embodiment in FIG. 1.

FIG. 3 is a front and back perspective view of the rack made in accordance with the principles of the embodiment in FIG. 1.

| | | | |
|---|---|---|---|
| 10 | Rack | 12 | Upper horizontal support |
| 14 | Lower horizontal support | 16 | Outer vertical bar |
| 18 | Support member | 20 | ‘T’ connector |
| 22 | ‘L’ connector | 24 | Inner vertical bar |
| 26 | Side frame | 28 | Upper ‘T’ connector |
| 30 | Short upper horizontal support | 32 | Lower ‘T’ connector |
| 34 | Short lower horizontal support | 36 | Central frame |

### DETAILED DESCRIPTION

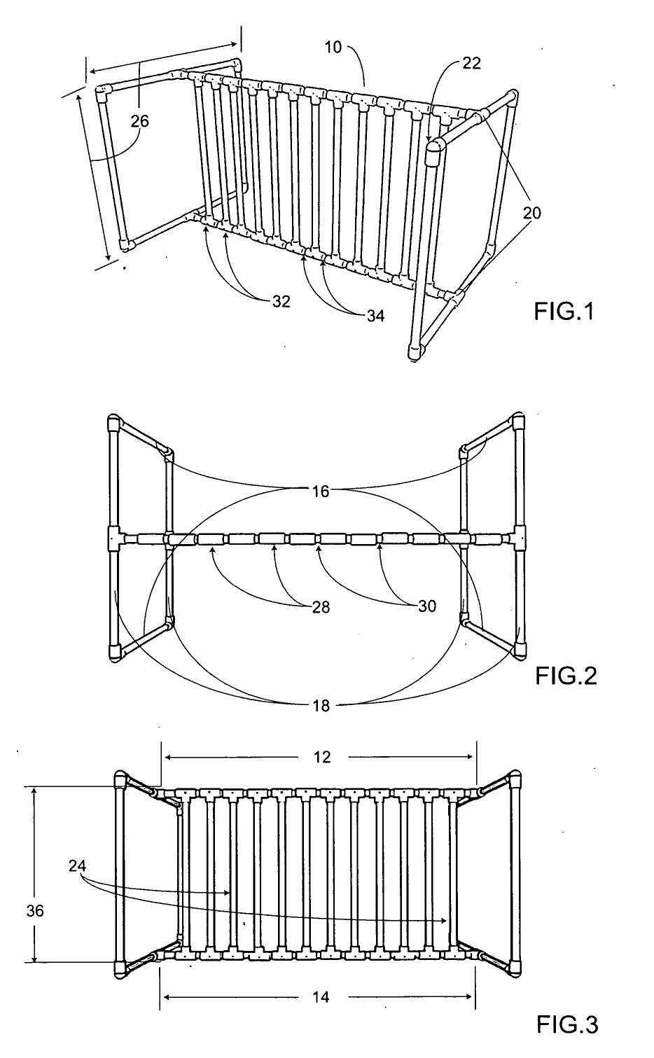

As seen in one embodiment in FIG. 1, a rack 10 includes two side frames 26 and a central frame 36. Said side frames include a vertical bar 16 positioned against the right side wall of a truck bed at the right rear wheel well and another vertical bar 16 positioned against the left side of a truck bed at the left rear wheel well. Another said vertical bar 16 is positioned against the right side wall where said right side wall meets the tailgate and another said vertical bar 16 is positioned against the left side wall where said left side wall meet the tailgate. Upper and lower ends of the left vertical bars 16 are joined by orthogonally positioned support members 18 using ‘L’ connectors 22 forming the generally rectangular left side frame 26. Upper and lower ends of the right vertical bars 16 are joined by orthogonally positioned support members 18 using L-shaped connectors 22 forming the generally rectangular right side frame 26. Left and right rectangular side frames 26 are connected by an orthogonally positioned upper horizontal support 12 and an orthogonally positioned lower horizontal support 14 adapted to extend longitudinally between the side walls of the truck bed of the truck using ‘T’ connectors 20 on support members 18. Said upper horizontal support 12 is comprised of a plurality of alternating short upper horizontal supports 30 and upper ‘T’ connectors 28. Said lower horizontal support 14 is comprised of a plurality of alternating short lower horizontal supports 32 and lower ‘T’ connectors 34. Said short horizontal supports 30 and 32 that are parallel in relation to each other are of substantially same length such that said ‘T’ connectors 28 and 34 that are adjacent to each other are substantially parallel in relation to each other. Said upper horizontal support 12 and said lower horizontal support 14 are connected at said ‘T’ connectors 28 and 34 that are parallel in relation to each other by a plurality of parallel inner vertical bars 24, forming generally rectangular slots to receive a bicycle wheel. Said inner vertical bars 24 and horizontal supports 12 and 14 form said central frame 36. The distance between said inner vertical bars 24 is set so that when a bicycle wheel is placed between them, it does not move excessively from side to side, maintaining the bicycle in a stable condition. At the same time, said inner vertical bars 24 are spaced far enough apart so that a significant portion of the wheel is between the bars without damaging the spokes.

Further detailed description, provided in the provisional application, is as follows. The invention (“EZ Rack”) is a bicycle rack suitable for positioning in a pick-up truck bed. The rack is fabricated out of elongated members, preferably plastic tubing (e.g., PVC pipe). EZ Rack is a product designed specifically for the transportation of multiple bicycles by pick-up truck. EZ Rack has dimensions slightly less than the interior dimensions of the truck bed for which it is adapted. The invention can be secured to a vehicle without the use of bolt or screw fasteners as the weight of the rack keeps it in place in the cargo bed. Neither the cargo bed, bed liner, nor truck body, are permanently deformed by screw or bolt holes as a result. The supporting legs of EZ Rack and the confines of the cargo bed keep it from moving laterally in the relatively flat cargo bed. Furthermore, the additional weight of bicycles within the open slats of EZ Rack helps to stabilize the rack from movement. It can accommodate bicycles of all sizes and both narrower wheels on common road bicycles and wider wheels on mountain bicycles. Bicycles are placed in the vertical position, therefore reducing the risk of damage to their bodies, components or finishes. At least six bicycles can be transported together in this manner.

The invention includes the following embodiments:

The bicycle rack as shown and described herein and in the figures.

A bicycle rack made from a plurality of tubular plastic members which in use is adapted for stable positioning within the bed of a pick-up truck, that may be positioned without the use of any fastening hardware that clamps onto, or into, or glues to, or penetrates any part of the truck or the truck bed or bed liner, that does not require permanent or semi-permanent fixture of the rack to any part of the truck or the truck bed or bed liner, wherein installation and removal into the truck bed requires no tools such as wrenches or screwdrivers or Allan keys, wherein between 1 and 6 bicycles may be carried safely in an upright position.

In one embodiment the rack comprises three elements attachable and detachable to one another. (1) A main frame comprising a plurality or parallel struts positioned together in the same plane (the first plane), each strut having a first end and a second end, the struts secured between two joists positioned at the ends of the struts, the joists being perpendicular to the struts, and within the same first plane as the struts; (2) at either end of the main frame, two side frames each one comprising a polygonal frame the sides of which are all in the same second plane, wherein each side frame is attachable to joists of the main frame, the side frame, when in use, being positioned in a second plane that is orthogonal to first plane of the main frame, wherein the joists are longer than the struts.

In one embodiment the joists are longer than any one of the sides of the polygonal frame. In one embodiment the polygonal frame has four sides. In one embodiment the polygonal frame has three sides.

In other embodiments the invention includes strap means for securing said bicycle storage rack in the cargo area of said truck, said strap means adapted for connecting said fastening means to opposite sidewalls of said truck so that the rack is braced within the cargo bed. In other embodiments the invention includes a mounting means for alternately mounting the bicycle storage rack in an upright position; and a securing means for securely locking one or more bicycles in the rack. The bicycle storage rack may be easily and quickly mounted to, and demounted from said truck.

EZ Rack was designed to address a need to transport multiple bicycles economically in the cargo bed of a pick-up truck. It allowed the user to easily acquire commonly available polyvinylchloride (PVC) plastic pipe and to effortlessly manipulate the pipe into custom and precise lengths in its construction. Assembly of the EZ Rack pieces took less than one minute and did not involve tools. The device provided for stable, safe, and secure transportation of bicycles over distances. When not in use, EZ Rack easily disassembled into three pieces for space-saving storage.

What is the currently used solution(s) to this problem? While there may be multiple solutions for transporting bicycles in the cargo bed of a pick-up truck, these products require alterations of the cargo bed or of the bicycle. Some commercial products available from Yakima, Inc. and Thule, Inc. may require attachment by bolting onto the cargo bed, or bed rail. This results in permanent deformation of the transport vehicle. Other products not permanently attached to the truck may require the user to inconveniently remove a wheel from the bicycle and then attach the bicycle by its front fork with hand tools to a metal skewer. Other solutions for transporting bicycles outside of the cargo bed include inserting the horizontal arm of a prefabricated vertical rack into a trailer hitch. The bicycle is then placed on top of horizontal arms protruding above and opposite the hitch arm. This requires that the truck has a hitch affixed to its frame or bumper. Such products available from Yakima, Inc. and Thule, Inc. appear to allow no more that four bicycles be transported simultaneously. Other products available from these companies include semi-permanently roof mounted bars and receiving trays.

What is the inventive solution? Transporting bicycles by truck has posed a number of problems and solutions. The easiest and least-expensive method involves simply placing the bicycles into the cargo bed and securing them to each other or the bed itself with ropes, elastic cords, rubber straps or not securing them at all. The drawback is that this method allowed movement of the bicycles while the truck is in motion. This posed a risk of damage to the frame and components of the bicycle, or damage to the paint finish. Companies such as Yakima, Inc. and Thule, Inc. evolved because they recognized a need to transport recreational equipment in a manner which resulted in minimal or no damage to the equipment's body or components. Years of research and development have resulted in product lines addressing overcoming these problems. Multiple product designs and applications have dealt with the various recreational equipment and the vehicles by which they are transported. These companies have developed products to transport skis, kayaks, boats, as well as bicycles by different makes and models of automobile, van, and truck. There were limitations, however, with products presently obtainable in the commercial marketplace.

EZ Rack is a product designed specifically for the transportation of multiple bicycles by pick-up truck. Its application may be universal among the various makes and models of pick-up trucks. I believe that cargo beds are standard within the truck industry. Most standard sized trucks have cargo beds that are approximately five feet wide at its widest point. Common bed lengths are six feet or eight feet long. The lengths of the bed vary with the make and model of the truck. Because this width seems standard among truck manufacturers, EZ Rack have universal appeal. EZ Rack measures slightly less than five feet from end to end. It can easily be placed in either the front or back of the bed, depending on owner preference. Because EZ Rack is pre-fabricated of lighter weight polyvinylchloride (PVC) pipe, it can be easily transferred in three pieces to the application site by one person and solitarily assembled on site within a minute and without the aid of hand or power tools. There is no need to secure EZ Rack to the vehicle via bolt or screw fasteners as the weight of the rack keeps it in place in the cargo bed. Neither the cargo bed, bed liner, nor truck body, are permanently deformed by screw or bolt holes as a result. The supporting legs of EZ Rack and the confines of the cargo bed keep it from moving laterally in the relatively flat cargo bed. Furthermore, the additional weight of bicycles within the open slats of EZ Rack helps to stabilize the rack from movement.

EZ Rack provides diversity in the transportation of multiple bicycles. The 29 inch tall by 3 inch wide open slat allows it to accommodate smaller diameter wheels found on children bicycles and larger diameter wheels on adult bicycles simultaneously. It can accommodate both narrower wheels on common road bicycles and wider wheels on mountain bicycles. Bicycles are placed in the vertical position, therefore reducing the risk of damage to their bodies, components or finishes. Based on this design, at least six bicycles can be transported together in this manner.

The fabrication of EZ Rack is economical. The rack is made of widely available PVC pipe. Current applications of PVC pipe include its use as a conduit of potable water in homes for human consumption and landscape irrigation. EZ Rack is constructed of various lengths of ¾ inch Schedule 40 PVC pipe and PVC fittings of various shapes and angles. The individual PVC cut shorter lengths are cemented to PVC fittings with commonly available PVC cement. The resultant three separate larger pieces of EZ Rack are then assembled together. No glue is used to connect the two supporting legs to the vertical slat assembly as friction is sufficient to interlock the pieces stably. The resultant is sturdy, stable, lightweight unit. Unlike other bicycle transporting systems, EZ Rack would use materials already widely available. Fabrication would not require costly tooling of machinery. Neither dies nor machines would be necessary to produce the parts that are assembled into EZ Rack. The result is reduced production costs. Automation may simply require jigs to faithfully and precisely cut raw pipe into finished lengths. Machinery may be needed to cement the individual lengths and fittings together.

EZ Rack has an ancillary function outside of its application as bicycle transporting device. Removed from the cargo bed and placed on the ground, it also serves as a storage device as well. Up to eleven bicycles (six on one side of the rack, five on the other side) can be parked in the upright position. Subsequently, the risk of damage from a bicycle falling and striking the ground is lessened. Because the bicycles are stored in closer proximity to one another, this decreases the need for individual locking mechanisms to secure the bicycles. One or two chain or cable locks may be all that is necessary to reduce the risk of theft of multiple bicycles.

### Operation

Referring to FIGS. 1, 2, and 3, the manner of using bicycle rack 10 is simple and quick for the user. In one embodiment, side frames 26 are permanently attached to central frame 36, said central frame 36 comprising two horizontal supports 12 and 14 and said plurality of inner vertical bars 24. In this embodiment, simply place said rack 10 in the truck bed positioned so that lower right support member 18 is between the right rear wheel well and the right side of the tailgate and lower left support member 18 is between the left rear wheel well and the left side of the tailgate. Side frames 26 will prevent lateral movement of rack 10 and horizontal supports 12 and 14 connecting side frames 26 will prevent longitudinal movement of rack 10. Simply place the rear wheel of each bicycle the user wishes to transport into a rectangular slot created by inner vertical bars 24 and horizontal supports 12 and 14.

In another embodiment, side frames 26 can be detached from central frame 36 for easy storage. If disassembled, attach side frames 26 to the central frame 36 by connecting the ends of upper horizontal support 12 to upper support members 18 using ‘T’ connectors 20 and connecting the ends of the lower horizontal support 14 to lower support members 18 using ‘T’ connectors 20. Then place assembled rack 10 into the truck bed as described above.

### Alternate and Additional Embodiments

The rack 10 may be fabricated and assembled in many other ways. The rack 10 can be made of metal or plastic such as PVC and it can be made in various combination of pieces. The rack 10, as shown in FIG. 1, is made of several straight pieces of polyvinylchloride (PVC) pipe 16, 18, 30, and 34, ‘L’ connectors 22, and ‘T’ connectors 20, 28, and 32 assembled as shown in FIG. 1. The straight pieces 16, 18, 30, and 34 could be secured by adhesive, screws, or in any other suitable way, eliminating the need for ‘L’ connectors 22 and ‘T’ connectors 20, 28, and 32. The rack 10 as shown in FIG. 1 uses relatively straight pieces of PVC piping. However, the inner and outer vertical bars 24 and 16, horizontal supports 12 and 14, and orthogonally placed support members 18 may be curved, zig-zagged, or patterned in another appropriate manner.

Another embodiment includes two outer vertical bars secured by two horizontal supports. Each end of the lower horizontal support is attached to orthogonally placed support members. Parallel inner vertical bars connect the two horizontal supports forming generally rectangular slots to receive the bicycle wheel.

Another embodiment may include two outer vertical bars secured by two horizontal supports. Each end of the lower horizontal support is attached to orthogonally placed support members. Each end of the support members are connected to the upper horizontal support by a diagonal bar, forming a triangular frame with the outer vertical bar.

Parallel inner vertical bars connect the two horizontal supports forming generally rectangular slots to receive the bicycle wheel.

Another alternate embodiment includes a single piece of tube or bar bent to the appropriate share, forming the outer vertical bars, upper and/or lower horizontal supports. A plurality of parallel inner vertical bars can be welded or otherwise secured to the single piece of tube or bar at the horizontal support portions. The support bars can be welded or otherwise secured to the support members at any appropriate portion of the outer vertical bars or the lower horizontal support.

Another alternate embodiment includes a plurality of vertical bars secured by two horizontal supports. The upper horizontal support is longer than the lower horizontal support and is placed at an upward angle. The inner vertical bars are adapted in increasing length as necessary to accommodate the angle of the upper horizontal bar in order to join the upper and lower horizontal bar forming generally rectangular slots of varying lengths.

Another embodiment includes a plurality of vertical bars secured at the lower ends by a lower horizontal support. The adjacent inner vertical bars in at least pairs are of the same length and joined at their top ends by a short upper horizontal support. These pairs or sets of inner vertical bars may be of varying lengths to accommodate different wheel heights. The outer vertical bars are joined with orthogonal support bars at one or both ends.

Alternate embodiments may include a means of securing the rack to the truck bed of the truck. One such embodiment may include straps, said straps comprising a single or plurality of straps and fastening means attached to opposite side walls of the truck bed. Other embodiments may include mounting means by clamps affixed to the side frames of the rack that attach to the side walls of the truck bed.

Alternate embodiments of the invention may include securing means for securely locking the transported bicycles to the rack. One such embodiment may include straps attached to the rack by welding, screws, or any other appropriate means which secure the bicycle to the rack. Other embodiments may include a retaining bar attached on one end to the rack by adhesive, welding, or other appropriate means, said retaining bar having a clamp or other appropriate securing device on the other end that may attach to the wheel or frame of bicycle.

### Objects and Advantages

Accordingly, one object of this invention is to provide a new and improved apparatus for transporting bicycles by use of a pick-up truck. Another object is to provide new and improved bicycle transportation racks which can be made inexpensively and without use of tools. A further object is to provide new and improved bicycle transportation racks that may be easily assembled and disassembled. Thus the invention is easy to assemble and use and may be disassembled without use of tools. In certain embodiments no tools are used to assemble an disassemble the rack. In certain embodiments the rack, when disassembled, may be laid flat in a box wherein no single component of the rack has a thickness greater than twice the thickness of the diameter of the widest tubular component. In one important embodiment the rack may be used to securely carry 1, 2, 3 or more bicycles wherein neither the front wheel nor the rear wheel needs to be removed to secure the bicycle(s) to the frame. In one embodiment, in use, the bicycle(s) may be secured to the frame while oriented “standing up”, placed upright with both wheels placed down on the bed of the truck. The term “upright position” refers to the position with the wheels placed on the ground, or possible slightly lifted off the ground by an element of the frame, such that the orientation is approximately that in which it is ridden. It is important to distinguish this carrying position from other orientations and it is important to note that the bicycle(s) may be placed securely on the rack with both the front and rear wheels still attached.

Yet another object is to provide new and improved bicycle transportation racks that are light-weight and easy to install and remove in a truck bed. Another object is to provide new and improved bicycle transportation racks that do not restrict access to the tailgate nor restrict use of the receiver hitch. Another object is to provide new and improved bicycle transportation racks which carry a greater number of bicycles with a single apparatus. A further object is to provide new and improved bicycle transportation racks which do not require disassembly of any part of the bicycle. Another object is to provide new and improved bicycle transportation racks which safely secure the transported bicycle(s), minimizing likelihood of damage in the event of a collision. A further object is to provide new and improved bicycle transportation racks that do not cause damage to the truck.

### Conclusion, Ramifications, and Scope

The many advantages of the invention are now apparent. A plurality of bicycles can be conveniently and safely stored and transported in the truck bed of a pick-up truck without damaging the truck or dismantling the bicycle. The rack allows its user to acquire widely available, inexpensive material such as PVC piping and adapt the pieces into custom lengths and numbers to suit their truck bed dimensions and hauling capacity needs. The rack is easily assembled and installed, requiring no tools. In many embodiments of the invention, the rack may be disassembled into three parts: the two side frames and the middle structure encompassing the horizontal supports and inner vertical bars. The optional disassembly allows for space-saving storage of the rack when not in use.

While the principles of the invention have been described above in connection with specific apparatus and applications, it is to be understood that this description is made only by way of example and not as a limitation on the scope of the claims.

We claim:

1. A bicycle rack for use with a truck having a truck bed with substantially parallel side walls and at least one bicycle having a frame and a wheel mounted on the rear or front bicycle fork of said frame, said bicycle rack comprising:
a. a plurality of horizontal supports adapted to extend longitudinally between the side walls of the truck bed,
b. a plurality of vertical bars and a means to affix said plurality of vertical bars in substantially upright position interposed between said horizontal supports, and
c. a plurality of support members adapted to extend between the rear wheel well and tailgate of said truck and a means to affix said plurality of support members orthogonally to said horizontal cross members and/or said vertical bars,
whereby said horizontal supports and said vertical bars form parallel open slots to receive said bicycle wheel.

2. The bicycle rack of claim 1 wherein, the distance between said vertical bars is such that when said bicycle wheel is placed between them, said bicycle wheel does not move excessively from side to side, whereby parallel open slots securely hold said bicycle wheel and thereby said bicycle in place, and whereby, in use, the bicycle, with both front and back wheels attached, is held in an upright position with both wheels down upon the truck bed.

3. The bicycle rack of claim 1 wherein:
a. said horizontal supports include one upper horizontal support and one lower horizontal support, said vertical bars are positioned upright and parallel in relation to each other, and a means to affix upper ends of said vertical bars perpendicularly to said upper horizontal support, and lower ends of said vertical bars affixed perpendicularly to said lower horizontal support, and
c. a means to affix said support members perpendicularly to opposing ends of at least the lower horizontal support is provided whereby said horizontal supports and said vertical bars form parallel open rectangular slots to receive said bicycle wheel, and wherein, in use, the distance between said vertical bars is such that when said bicycle wheel is placed between them, said bicycle wheel does not move excessively from side to side, whereby parallel open slots securely hold said bicycle wheel and thereby said bicycle in place.

4. The bicycle rack of claim 1 wherein:
a. said horizontal supports include one upper horizontal support and one lower horizontal support,
b. said vertical bars include at least two outer vertical bars and a plurality of inner vertical bars,
c. said inner vertical bars are positioned upright and parallel in relation to each other, a means to affix upper ends of said inner vertical bars perpendicularly to said upper horizontal support, and a means to affix lower ends of said vertical bars perpendicularly to said lower horizontal support, and
d. a means to affix said support members to at least to the lower ends of said outer vertical bars is provided whereby said horizontal supports and said vertical bars form parallel open rectangular slots to receive said bicycle wheel, and wherein, in use, the distance between said vertical bars is such that when said bicycle wheel is placed between them, said bicycle wheel does not move excessively from side to side, whereby parallel open slots securely hold said bicycle wheel and thereby said bicycle in place.

5. A bicycle rack for use with a truck having a truck bed with substantially parallel side walls and at least one bicycle having a frame and a wheel mounted on the rear or front bicycle fork of said frame, said bicycle rack comprising:
a. a plurality of horizontal supports adapted to extend longitudinally between the side walls of the truck bed,
b. a plurality of vertical bars including a plurality of inner vertical bars and a plurality of outer vertical bars, said inner vertical bars positioned substantially upright and parallel in relation to each other, a means of affixing each end of said inner vertical bars interposed between said horizontal bars,
d. a plurality of support members adapted to extend between the rear wheel well and tailgate of said truck, a means of affixing said plurality of support members to orthogonally to said horizontal supports and/or said outer vertical bars, and
e. a means of affixing said outer vertical bars orthogonally to said support members and/or said horizontal supports whereby said horizontal supports and said vertical bars form parallel open slots to receive said bicycle wheel wherein, in use, the distance between said vertical bars is such that when said bicycle wheel is placed between them, said bicycle wheel does not move excessively from side to side, whereby parallel open slots securely hold said bicycle wheel and thereby said bicycle in place.

6. The bicycle rack of claim 4 wherein:
a. said vertical bars consist of at least four outer vertical bars and a plurality of inner vertical bars,
b. at least two said outer vertical bars positioned at each opposing side wall of said truck bed,
c. and a means of affixing said outer vertical bars to said support members and/or said horizontal supports is provided whereby said outer vertical bars and said support members form two polygonal side frames to which said horizontal supports are attached and the distance between said vertical bars is such that when said bicycle wheel is placed between them, said bicycle wheel does not move excessively from side to side, whereby parallel open slots securely hold said bicycle wheel and thereby said bicycle in place.

7. The bicycle rack of claim 5 wherein:
a. said support members include two upper support members and two lower support members,
b. said horizontal supports include an upper horizontal support and an lower horizontal support, and further comprising
c. a means of affixing upper ends of said outer vertical bars to ends of said upper support members is provided,
d. a means of affixing lower ends of said outer vertical bars to ends of said lower support members is provided,
e. a means of affixing said upper support members to opposing ends of said upper horizontal support is provided,
f. a means of affixing said lower support members to opposing ends of said lower horizontal support is provided, whereby outer vertical bars, upper support member, and lower support member form two generally rectangular side frames positioned against opposing side walls of said truck bed and whereby horizontal supports and said inner vertical bars form parallel open rectangular slots to receive said bicycle wheel and whereby, in use, the distance between said vertical bars is such that when said bicycle wheel is placed between them, said bicycle wheel does not move excessively from side to side, whereby parallel open slots securely hold said bicycle wheel and thereby said bicycle in place.

8. The bicycle rack of claim 5 wherein:
a. said horizontal supports include one upper horizontal support and one lower horizontal support,
b. a means of affixing said support members include one support member orthogonally to each end of said lower horizontal support,
c. at least two said outer vertical bars are positioned at each opposing side wall of said truck bed, a means of affixing lower ends of said outer vertical bars orthogonally to said support members, a means of affixing upper ends of said vertical bars orthogonally to said upper horizontal support,
whereby said support members and said outer vertical bars form two triangular side frames positioned at opposing side walls of said truck bed and wherein the distance between said vertical bars is such that when said bicycle wheel is placed between them, said bicycle wheel does not move excessively from side to side, whereby parallel open slots securely hold said bicycle wheel and thereby said bicycle in place.

9. A bicycle rack made from a plurality of tubular plastic component members which in use is adapted to provide stable positioning within the bed of a pick-up truck, wherein the rack may be assembled from the component members and positioned into the bed of the pick-up truck without the use of any fastening hardware that screw or clamp onto, or into, or glues to, or penetrates any part of the truck or the truck bed or bed liner, and that does not require permanent or semi-permanent fixture of the rack to any part of the truck or the truck bed or bed liner, wherein installation and removal into the truck bed requires no tools, wherein at least four bicycles may be carried safely in an upright position, the bicycle rack comprising (1) a main frame comprising a plurality or parallel struts positioned together in the same plane (the first plane), each strut having a first end and a second end, the struts secured between two joists positioned at the ends of the struts, the joists being perpendicular to the struts, and within the same first plane as the struts; (2) at either end of the main frame, two side frames each one comprising a polygonal frame the sides of which are all in the same second plane, wherein each side frame is attachable to joists of the main frame, the side frame, when in use, being positioned in a second plane that is orthogonal to first plane of the main frame, wherein the joists are longer than the struts, wherein the joists are longer than any one of the sides of the polygonal frame, and wherein, in use, a bicycle, with both front and back wheels attached, is held in an upright position with both wheels down upon the truck bed.

10. The bicycle rack of claim 9 wherein the joists are longer than any one of the sides of the polygonal frame.

11. The bicycle rack of claim 9 wherein the polygonal frame has four sides.

12. The bicycle rack of claim 9 wherein the polygonal frame has three sides.
